(19) United States
(12) Patent Application Publication
(10) Pub. No.: US 2026/0266600 A1
(43) Pub. Date: Sep. 10, 2026

(54) AUTOMATED SCANNING ELECTRON MICROSCOPY ANALYSIS OF MINERAL WOOL FIBER DIAMETER

(71) Applicant: UNITED STATES GYPSUM COMPANY, Chicago, IL (US)

(72) Inventor: Luka BADURINA, Chicago, IL (US)

(21) Appl. No.: 19/371,538

(22) Filed: Oct. 28, 2025

Related U.S. Application Data
(60) Provisional application No. 63/767,060, filed on Mar. 5, 2025.

(51) Int. Cl. G01B 15/00; G01N 23/20008; G01N 23/203

(52) U.S. Cl. CPC G01B 15/00; G01N 23/20008; G01N 23/203

(57) ABSTRACT

A method for automated scanning electron microscopy (SEM) analysis of mineral wool fiber diameter, including preparing a sample of mineral wool fibers for testing, including sieving the sample, conducting SEM imaging of the sample, such that each image of the sample is collected using a back-scatter electron (BSE) detector, and automatically analyzing the image of the sample, the analyzing the image providing information regarding diameters of the mineral wool fibers in the sample.

### RELATED APPLICATION

The present application claims 35 USC 119 priority from U.S. Provisional Application Ser. No. 63/767,060 filed Mar. 5, 2025, the contents of which are incorporated by reference herein.

### BACKGROUND

The present disclosure relates to methods of determining a diameter of mineral wool and related types of man-made vitreous fibers utilizing automated scanning electron microscopy (SEM).

Mineral wool fiber diameter is an important variable in both the development of ceiling tiles with improved acoustic performance, and the development of in-vitro fiber bio-solubility testing. Thus, there have been ongoing efforts to increase mineral wool fiber diameters for improved acoustic performance.

Each of these considerations benefit from improved information on mineral wool fiber diameters, especially in scenarios where <1 μm differences in fiber populations would need to be reliably detected. Additionally, mineral wool fiber diameter is an important variable in the study of mineral wool fiber dissolution.

Typically, measurement of mineral wool fiber diameter is conducted using a Diamscope instrument, which is an industry standard for measuring diameter of mineral wool fibers. Specifically, the Diamscope images fibers in a turbulent water column and rapidly measures (<5 minutes per sample) their lengths and diameters. While the Diamscope enables considerable throughput and reproducibility in quality control setting, some limitations have been reported due to the nature of its operation.

Further, while the Diamscope is highly reproducible over short timespans, slight drifting of measurements has also been reported. Additionally, due to the nature of analysis where materials are suspended in turbulent water bath, there is a possibility that fibers of different dimensions will exhibit different behavior when stirred in water medium, potentially leading to different measurement biases, such that certain fiber dimensions are preferentially over or under counted.

Also, the Diamscope only works on disaggregated mineral wool samples suspended in stirred water bath, which precludes measurements of dry, or “in-situ,” materials. Moreover, the data received from the Diamscope exhibits limitations due to its mode of operation where fibers are imaged in turbulent water column, rather than on a dry and static environment of a sample holder. Accordingly, there is the need for a new method for more accurate mineral fiber diameter determination.

### SUMMARY

The above-listed need is met or exceeded by the present method for automated scanning electron microscopy analysis of mineral wool fiber diameter. Specifically, the presently disclosed method uses automated scanning electron microscope (SEM) analysis in combination with Image-Pro software for mineral fiber diameter determination. Image-Pro is considered an industry standard for material science analysis and is routinely used for fiber characterization in academic and industry settings.

The automated SEM and Image-Pro method is able to achieve measurement accuracy well below 0.2 μm, which is a practical threshold of optical microscopy upon which the Diamscope is based. SEM measurement accuracy is preferably calibrated using NIST-certified standards, providing improved traceability and validation of the instrument's performance. Since the presently disclosed method measures dry and static samples, it does not exhibit potential measurement artefacts related to different behaviors of varying fibers size in turbulent water medium, thus reducing measurement biases of Diamscope.

Thus, the present method provides an improved approach for determining a diameter of mineral wool and related types of man-made vitreous fibers and involves a comprehensive sample preparation procedure combined with automated scanning electron microscopy analysis using specialized image processing software. Further, the present method produces datasets with improved lognormal distribution, which is consistent with literature data, and was previously not achievable with current methods that produce multi-modal distributions (e.g., Diamscope, manual measurements).

More specifically, the present disclosure includes a method for automated scanning electron microscopy (SEM) analysis of mineral wool fiber diameter, including preparing a sample of mineral wool fibers for testing, including sieving the sample, conducting SEM imaging of the sample, such that each image of the sample is collected using a back-scatter electron (BSE) detector, and automatically analyzing the image of the sample, the analyzing of the image providing information regarding diameters of the mineral wool fibers in the sample.

The present disclosure also includes a mineral wool ceiling tile, and a mineral wool insulation product made using fibers having an average diameter selected using the presently disclosed method.

### BRIEF DESCRIPTION OF THE DRAWINGS

FIG. 1 is a block diagram showing the steps of a method for automated scanning electron microscopy (SEM) analysis of mineral wool fiber diameter;

FIG. 2 illustrates a first sub-step of an automated image analysis step of the presently disclosed method which includes opening an image of interest, defining a region of interest (ROI), and defining a scale;

FIG. 3 illustrates a second sub-step of the automated image analysis step which includes determining parameters of image masking;

FIG. 4 illustrates a third sub-step of the automated image analysis step which includes previewing the fiber diameter determination, where each blue line represents a single fiber diameter measurement. Annotations in yellow display approximate image regions that are expanded in FIGS. 5 and 6 for better visibility of individual measurements;

FIG. 5 illustrates an enlarged area from FIG. 4 which shows individual fiber measurements;

FIG. 6 illustrates an enlarged area from FIG. 4 which shows individual fiber measurements;

FIG. 7a shows mean interval plots for measurements conducted according to the present method and measurements conducted according to convention testing using the Diamscope for sample B17;

FIG. 7b illustrates mean interval plots for measurements conducted according to the present method and measurements conducted according to convention testing using the Diamscope for sample B36;

FIG. 8a shows relative frequency histogram plots for measurements conducted according to the present method and measurements conducted according to convention testing using the Diamscope for sample B17. Each histogram was fitted with lognormal fit. All plots share identical x and y axes for ease of comparison;

FIG. 8b shows relative frequency histogram plots for measurements conducted according to the present method and measurements conducted according to convention testing using the Diamscope for sample B36. Each histogram was fitted with lognormal fit. All plots share identical x and y axes for ease of comparison;

FIG. 9 shows histograms and descriptive statistics of B17 and B36 samples prepared with regular Diamscope preparation technique (samples labeled “REGULAR”) and samples prepared with sieving (labeled “SIEVED”) though <25 μm;

FIG. 10 shows histogram and statistics of identical B36 samples imaged at 200 times and 500 times magnifications; and

FIG. 11 show relative frequency histogram plots for SEM and Diamscope measurements for a mineral wool sample produced by a different process.

### DETAILED DESCRIPTION

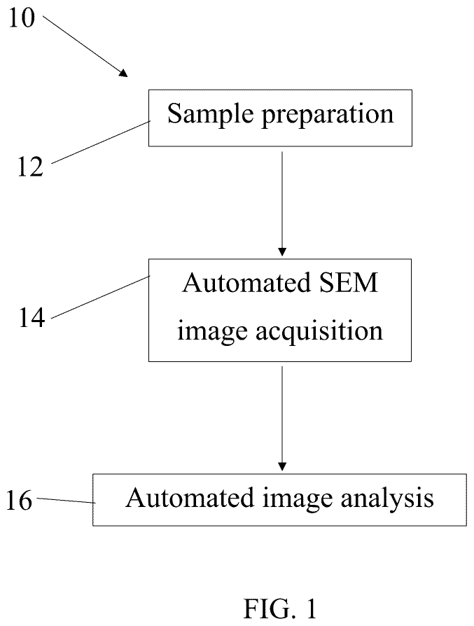

Referring now to FIGS. 1-6, and according to an example embodiment of the present disclosure, a method 10 for automated scanning electron microscopy (SEM) analysis of mineral wool fiber diameter includes a sample preparation step 12, an automated SEM image acquisition step 14, and an automated image analysis step 16. The Applicant conducted experiments with two mineral wool fiber samples, namely B17 and B36, using a convention Diamscope instrument and the present method 10.

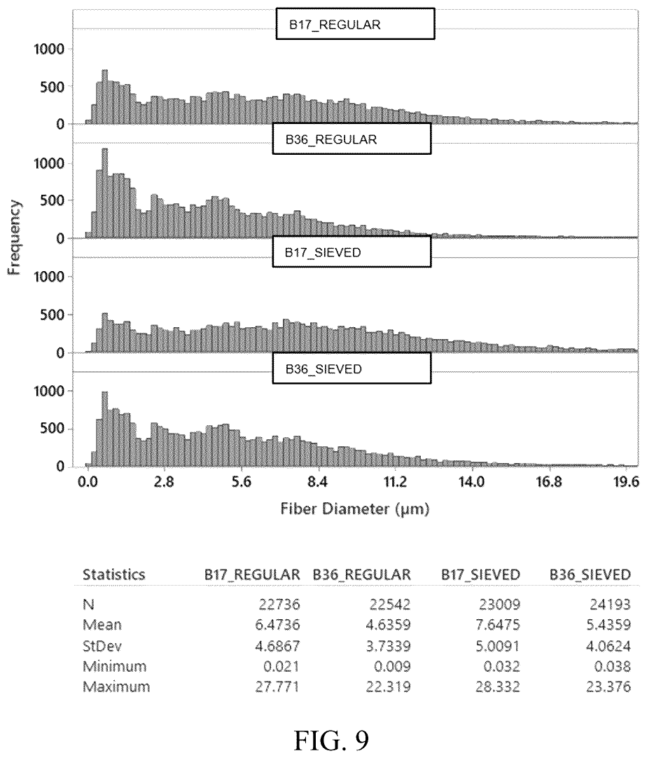

For each sample used for conventional testing using the Diamscope instrument, three random bundles of fiber were separated, and cut to about ~0.7 mm fiber length using a small guillotine. Following this, the samples were loaded into a measuring bowl and measured using routine mineral wool fiber protocol. Both samples were sampled within less than one hour from each other and were determined to exhibit ~2 μm fiber diameter difference (B17=~ 6 μm, B36=~ 4 μm) using the convention Diamscope instrument. Additionally, <25 μm sieved samples (described in greater detail below in relation to the preparation step 12), were ran in the Diamscope to determine how sieving affects the Diamscope measurements (see FIG. 9).

In the sample preparation step 12 of the present method 10, several grams of mineral wool fiber are separated from a fiber bundle and carefully sieved through a 25 μm diameter sieve to remove shot and flakes to form a sample. Following that, the sieved sample is thoroughly homogenized in a plastic tube, and three separate 0.2 mg sieved samples are mixed with 10 ml of isopropyl alcohol to form three aqueous samples. The three aqueous samples are then ultrasonicated, vigorously mixed and vacuum-filtered on a 0.2 μm Millipore filter paper. After filtration, using a carbon tape, the filtered sample is glued on a 1-inch aluminum stub holder, and carbon coated.

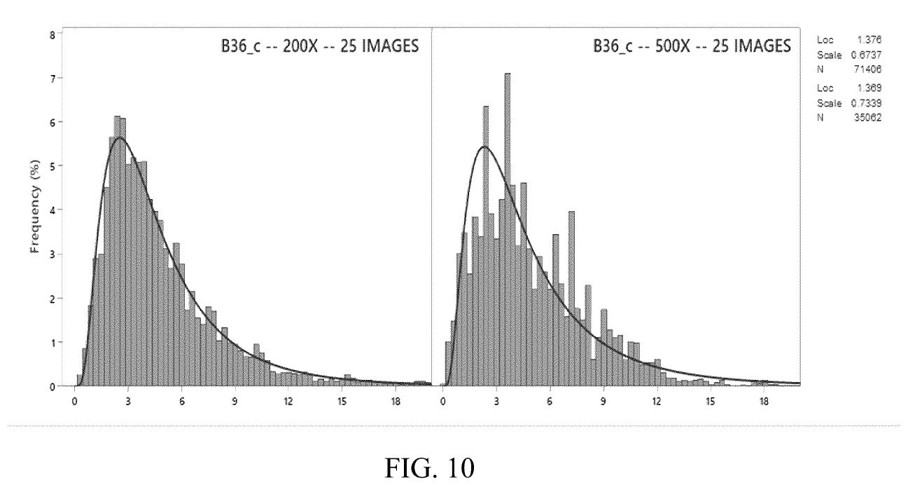

In the automated SEM image acquisition step 14, a Bruker Quantax automated image collection feature is used. For each sample, 25 images are collected. Each image is collected using a back-scatter electron detector (BSE) at 200 times magnification and at 4096×3072 maximum resolution. The resulting image scale is 7 pixels per 1 μm, which was empirically determined to provide optimal number of imaged fibers without compromises in detection of <1 μm fiber fractions. This image scale also provides a large enough number of fibers in the field of view (see FIG. 10).

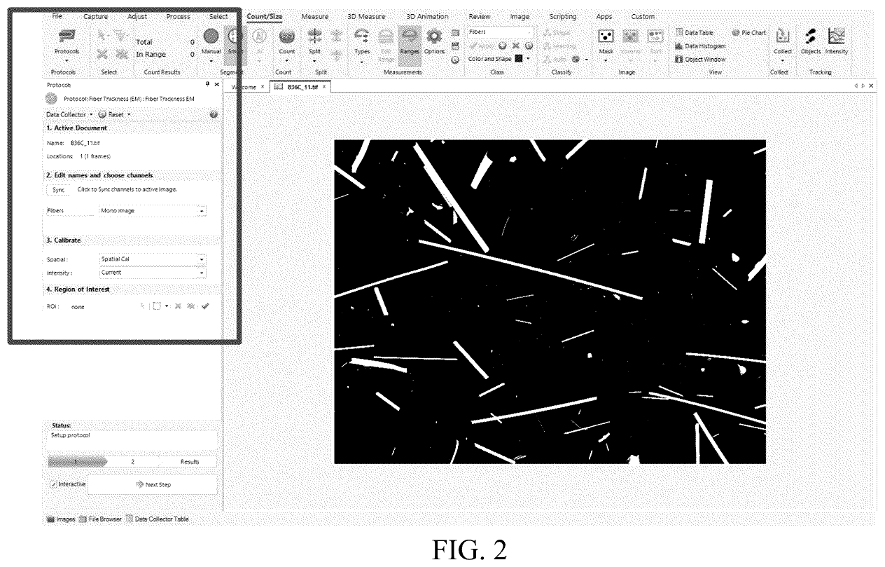

In the automated image analysis step 16, MediaCybernetics Image-Pro Software with Electron Microscopy Fiber Thickness module is used. The 25 previously collected images are loaded into the software as a batch. As shown in FIG. 2, the Region of Interest (ROI) and scale are set for the processing.

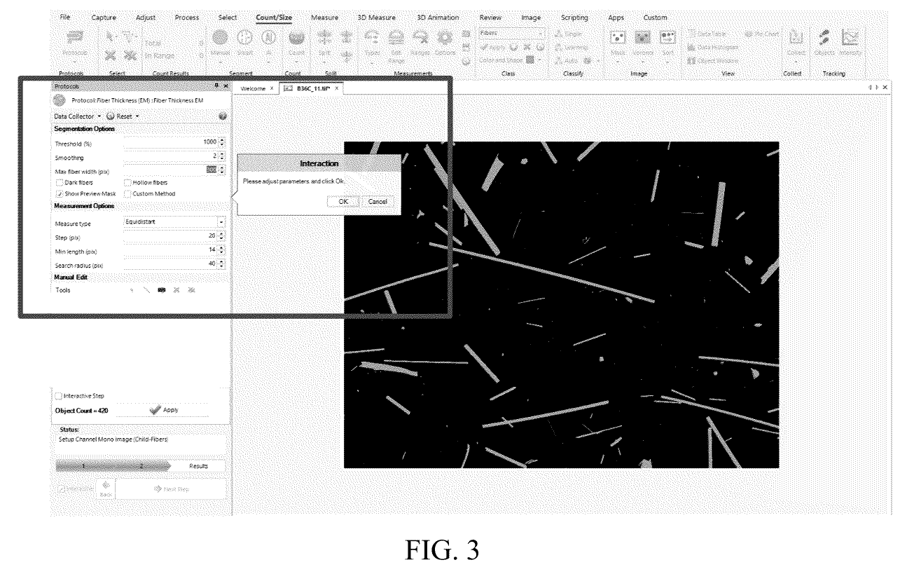

Afterwards, specific image masking parameters are selected, which are adjusted to allow the most accurate differentiation of imaged fibers from the background. As shown in FIG. 3, the parameters of image masking are selected for suitable image segmentation parameters which best differentiate features of interest. During this process a user optionally observes an overlay which assists in choosing the best masking parameters.

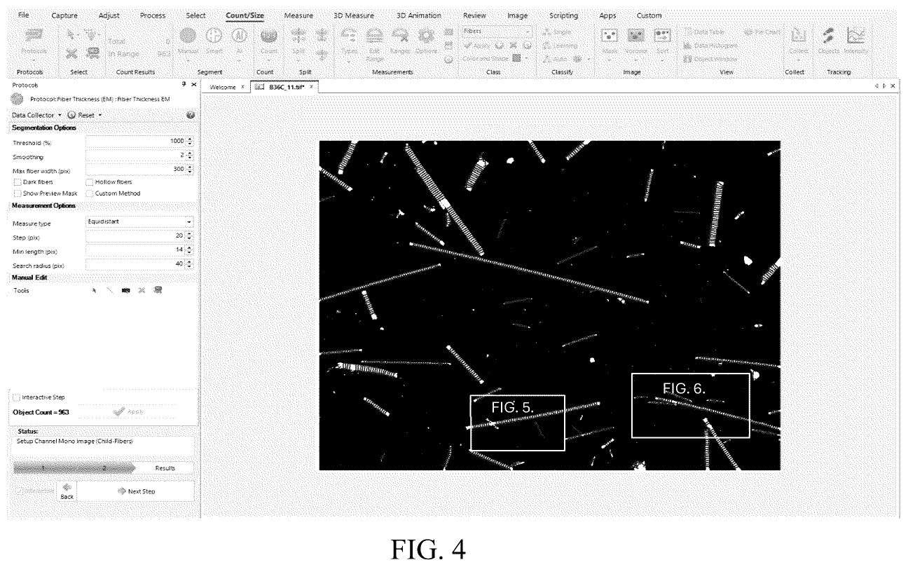

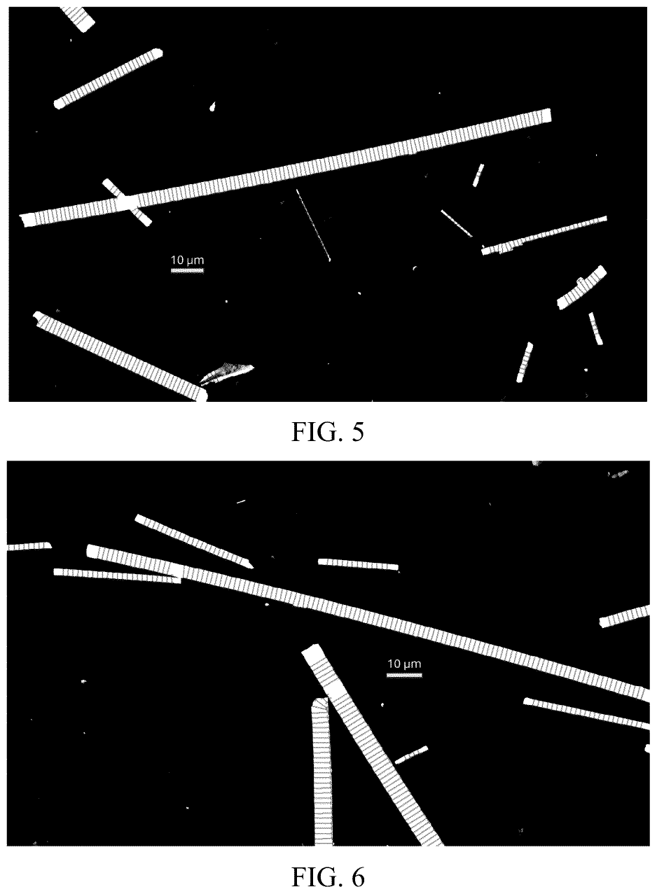

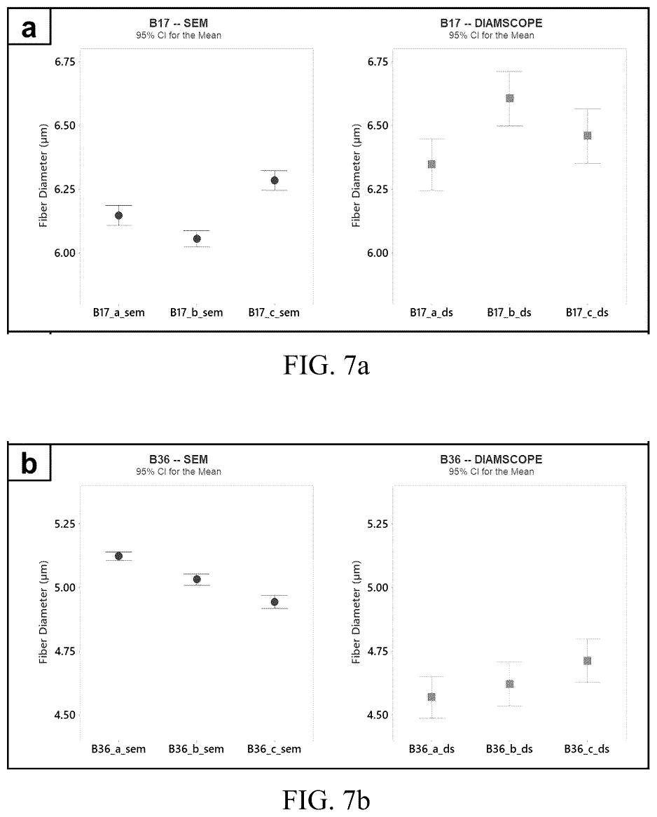

As shown in FIG. 4, image processing determines a density of fiber diameter measurements in pixel step size (i.e., 20-pixel step size will measure 100-pixel long fiber 5 times). Considering the principle of measurements, this method is considered as length-weighted fiber diameter estimation, which is comparable to the Diamscope approach. In this embodiment, 20 pixels step size is determined as appropriate. Additionally, a minimal fiber length (empirically determined at 2 μm), maximum fiber width (empirically determined at ~40 μm), and search radius are optionally defined. The impact and importance of parameters is preferably determined in the interactive overview in FIGS. 5 and 6, where overlay of individual measurements on individual fibers is observable, and a user optionally adjusts measurement parameters as needed.

The Electron Microscopy Fiber Thickness module uses specialized algorithms to segment fiber features in the images which resolve the issue of overlapping fibers, which is a common challenge in automated SEM fiber feature analysis. If a fiber is 10 μm (70 pixels) long, its diameter is measured three times using this setup (e.g., 20 pixels step size).

After all the parameters have been established, the software runs automated measurements on 25 images and produces data with all individual measurements. On average, 100,000 to 250,000 fiber diameter measurements are acquired per sample. Once the data is exported, a user is able to calculate mean fiber diameter from the bulk dataset, as well as observe valuable patterns in fiber diameter size distributions.

Notably, the newly proposed automated SEM method is able to reduce the biases experienced by conventional Diamscope measurements. Furthermore, the automated SEM method reveals a fiber diameter distribution that is well-fitted with lognormal distribution, which was not evident in Diamscope measurements that displayed multi-modal distributions. This is of some importance since lognormal distributions are recognized in literature as a common feature of man-made vitreous fibers. Considering this, preliminary results suggest that automated SEM/Image-Pro fiber analysis is preferably in scenarios where high accuracy is important, such as fiber acoustic performance studies, fiber dissolution experiments, and competitive analyses.

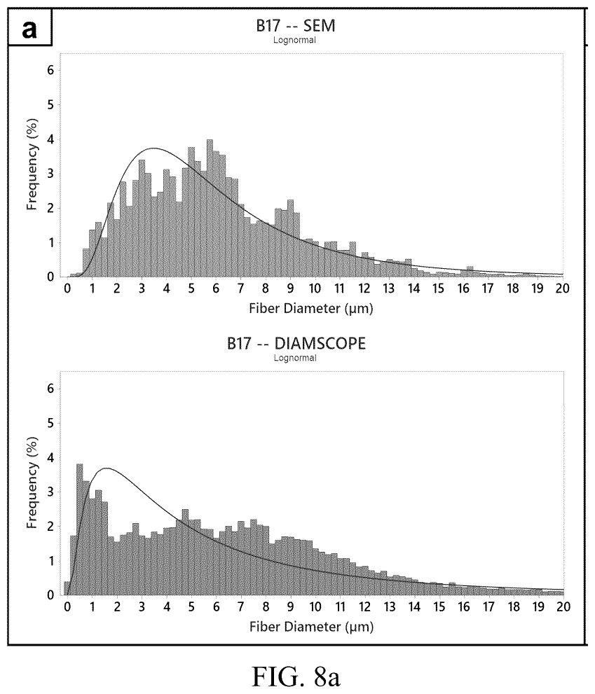

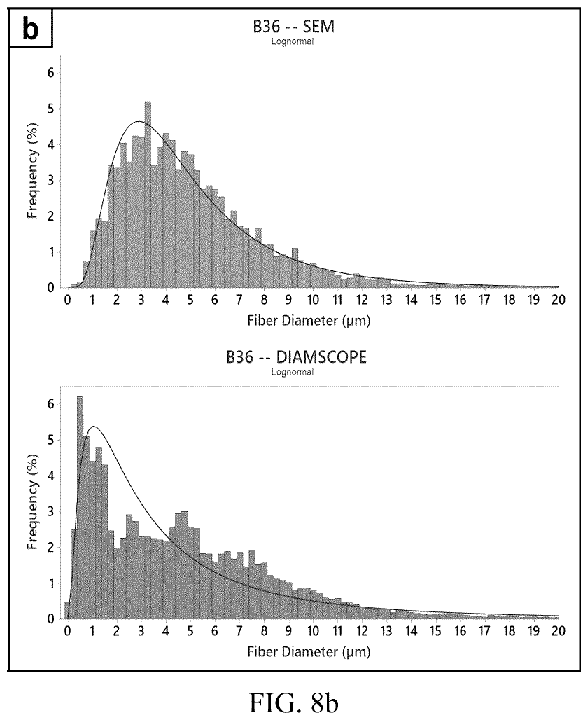

Table 1 displays data from tests conducted according to the method 10 and according to conventional testing parameters with the Diamscope. In both samples, absolute differences are about ~0.4 μm. Graphical display of means of individual measurement for each sample are shown in FIGS. 7a-7b. Differences in fiber diameter distributions may be observed in summarized histograms, which are displayed in FIGS. 8a-8b.

TABLE 1

| Sample | Method | N | Mean | St. Dev. | Q1 | Median | Q3 |
|---|---|---|---|---|---|---|---|
| B17 | SEM | 101,727 | 6.1 | 3.4 | 3.6 | 5.7 | 8.2 |
| B17 | Diamscope | 22,736 | 6.5 | 4.7 | 2.7 | 5.9 | 9.2 |
| B36 | SEM | 249,007 | 5.0 | 3.1 | 2.9 | 4.4 | 6.4 |
| B36 | Diamscope | 22,542 | 4.6 | 3.7 | 1.5 | 4.0 | 6.8 |

As shown in Table 1, both methods are broadly in agreement. However, the histograms shown in FIGS. 8a-8b suggest comparatively large fraction of <2 μm particles, which can be quantified by substantial differences in first quartile (Q1; 25th percentile) values for each sample, where sample B17 displays value of 3.6 μm (SEM) vs 2.7 μm (Diamscope) and sample B36 2.9 μm (SEM) vs. 1.5 μm (Diamscope). One possible explanation for the relative absence of <2 μm fraction in SEM measurements is that the different sample preparation for SEM measurements (<25 μm sieving) has preferentially eliminated fibers with such diameter range. If this were the case, one would expect that if <25 μm sieved fraction was measured in Diamscope, similar absence of <2 μm fraction would be detected. Such measurements were performed (FIG. 9), and the Diamscope still displays outsized <2 μm fiber diameter fraction, suggesting that sample preparation for SEM does not preferentially eliminate <2 μm fraction.

Importantly, it seems that both SEM histograms are modelled well with lognormal distribution curve (FIGS. 8a-8b), which has been reported in literature as a common feature of mineral wool fibers. Such distribution is not readily evident with multi-modal distribution present in Diamscope measurements (FIGS. 8a-8b).

This difference suggests that the Diamscope potentially overestimates the proportion of extremely fine fractions in mineral wool fiber. One possible explanation for the overestimation lies in the fact that while the Diamscope reports ~20% of fibers having diameter<2 μm (especially sample B36), the relatively high abundance of such fibers is not evidenced by testing conducted according to the method 10. Another possible explanation is based on the differences in behavior of different size fractions in a stirred water column. It is possible that sub <2 μm particle tend to move faster, or exhibit some other kind of specific behavior, where the Diamscope optical apparatus simply takes more images and measurements of this fraction.

Other than fibers, it is well known that many mineral species that commonly appear in <2 μm particle size range (e.g., clay minerals) display much more complex behaviors in turbulent water column when compared to mineral species of larger diameters, which commonly causes issues with many models of particle size analyzers. This data further demonstrates differences of the Diamscope compared to the present method 10 of automated scanning electron microscopy analysis.

FIG. 9 includes a histogram and descriptive statistics of samples prepared with regular a Diamscope preparation technique (samples labeled “REGULAR”), as well as samples prepared with sieving (labeled “SIEVED”) though <25 μm. While sieving seems to reduce <2 μm fiber diameter fraction, absolute fiber diameter seems to drastically increase, which suggests <25 μm sieving may be unsuitable for testing conducted with the Diamscope. Similarly, FIG. 10 includes a histogram and statistics of identical sample imaged at 200 times magnification and 500 times magnifications. The results show that the mean value is very close between the two magnifications, and that 200 times magnification images result in a better lognormal fit, as well as a higher measurement count. This data was used to verify that SEM does not significantly change fiber diameter values in response to significant magnification changes.

Fibers analyzed by the presently disclosed method 10 are preferably selected and optimized for use in the manufacture of insulation products, ceiling tiles and other products that use mineral wool, rock wool and/or glass fibers. Mineral wool, rock wool and glass fibers are commonly used to manufacture insulation products, ceiling tile products and various other products. For example, U.S. Pat. No. 1,769,519 to King et al., incorporated herein by reference, discloses sound absorbing or acoustical materials and the methods of manufacturing same. The base of the composition preferably includes fibrous materials, such as cellulose fibers or other lightweight materials which are suitable.

Further, U.S. Pat. No. 9,040,153 to Yeung, incorporated herein by reference, discloses a method of reducing sag of a mineral wool ceiling tile and a product thereof, and U.S. Patent Application Publication No. 2019/0263701 to Shock et al., incorporated herein by reference, discloses processes for producing molten glasses from glass batches using turbulent submerged combustion melting, and systems for carrying out such processes.

Moreover, U.S. Patent Application Publication No. 2024/0301985 to Hampson et al., incorporated herein by reference, discloses methods for manufacturing mineral wool insulation, for example glass wool or stone wool insulation, and to mineral wool insulation products. Accordingly, the present method 10 preferably improves the acoustic properties of insulation products, ceiling tiles and other products that use mineral wool, rock wool and/or glass fibers.

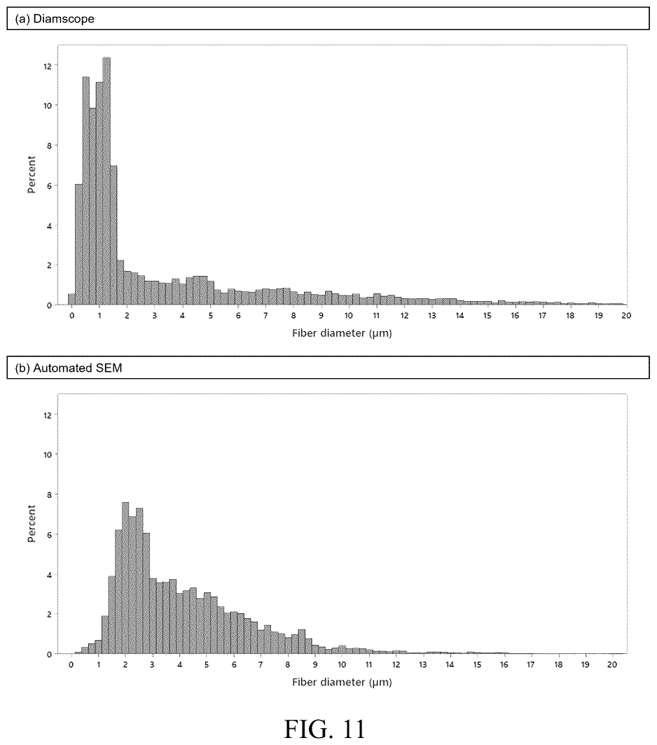

Referring now to FIG. 11, in order to evaluate an alternative mineral wool manufacturing process, the present Applicant performed the method 10 for automated SEM analysis on a mineral wool sample produced using a different manufacturing process. The primary objective was to determine whether this process results in fibers with diameters that are larger, smaller, or similar compared to those generated by the reference manufacturing process corresponding to samples B17 & B36.

Table 2 displays data of SEM and Diamscope fiber diameter measurements of mineral wool samples produced by a different process. Differences in fiber diameter distributions may be observed in summarized histograms, which are displayed in FIG. 11.

TABLE 2

| Sample | Method | N | Mean | St. Dev. | Q1 | Q3 |
|---|---|---|---|---|---|---|
| Mineral Wool | SEM | 143,255 | 4.2 | 2.6 | 2.3 | 5.4 |
| Mineral Wool | Diamscope | 20,602 | 3.3 | 4.0 | 0.8 | 4.6 |

The fiber diameter analyses found that the mean fiber diameter measured by the Diamscope was approximately 3.3 μm for the new process (Table 2), with extremely pronounced <2 μm histogram fraction (FIG. 11), where the automated SEM method 10 measured the mean fiber at about 4.2 μm (Table 2), with significantly lower <2 μm fraction (FIG. 11).

The distinction between the two fiber diameter measuring methods is notable. Relying solely on the Diamscope data suggests that the different manufacturing process produces fibers approximately 30-50% thinner than those from the reference process used for samples B36 and B17. In contrast, the automated SEM method 10 shows much smaller differences in fiber diameter, only 8% and 18% compared to samples B36 and B17, respectively. Based on the automated SEM method 10 results, fibers produced by the alternative process closely match those from the reference process in both average diameter (see Table 2) and diameter distribution (see FIG. 11). This suggests a higher level of consistency between the two manufacturing methods. Thus, the data from the SEM method 10 indicate that the alternative process yields fibers comparable in size to those from the reference process, while the Diamscope measurements may have overstated the differences and led to a misleading conclusion about the suitability of the new process.

While a particular embodiment of the present method of automated scanning electron microscopy analysis of mineral wool fiber diameter has been described herein, it will be appreciated by those skilled in the art that changes and modifications may be made thereto without departing from the invention in its broader aspects and as set forth in the following claims.

1. A method for automated scanning electron microscopy (SEM) analysis of mineral wool fiber diameter, comprising:
preparing a sample of mineral wool fibers for testing, including sieving said sample;
conducting SEM imaging of said sample, such that each image of said sample is collected using a back-scatter electron (BSE) detector; and
automatically analyzing said image of said sample, said analyzing of said image providing information regarding diameters of said mineral wool fibers in said sample.

2. A mineral wool ceiling tile made using fibers having an average diameter selected using the method of claim 1.

3. A mineral wool insulation product made using fibers having an average diameter selected using the method of claim 1.
